(19) United States
(12) Patent Application Publication
(10) Pub. No.: US 2024/0386525 A1
(43) Pub. Date: Nov. 21, 2024

(54) Method and Device for Pelvic Registration, Computer-readable Storage Medium and Processor

(71) Applicant: BEIJING YIDIANLINGDONG TECHNOLOGY CO., LTD., Beijing (CN)

(72) Inventor: Chao LI, Beijing (CN)

(21) Appl. No.: 18/271,466

(22) PCT Filed: Aug. 10, 2022
(86) PCT No.: PCT/CN2022/111517

§ 371 Date: Jul. 10, 2023

(30) Foreign Application Priority Data
Mar. 1, 2022 (CN) 202210189357.3

(51) Int. Cl. G06T 3/14; G06T 7/33

(52) U.S. Cl. CPC G06T 3/14; G06T 7/344; G06T 2200/04; G06T 2207/30008

(57) ABSTRACT

Provided are a method and device for pelvic registration, a computer-readable storage medium and a processor. The method includes: registering a three-dimensional model of a pelvis with an actual pelvis according to M first marker points to obtain primary registration model and primary registration matrix; registering the primary registration model with the actual pelvis according to N second marker points to obtain secondary registration model and secondary registration matrix; deleting second marker points having first registration errors greater than an error threshold and determining remaining second marker points as third marker points; registering the primary registration model with the actual pelvis according to the plurality of third marker points to obtain tertiary registration model and tertiary registration matrix; determining a registration matrix corresponding to a less one of a mean of first registration errors and a mean of second registration errors as an optimized registration matrix.

### CROSS-REFERENCE TO RELATED APPLICATION

The disclosure claims the benefit of priority to Chinese Patent Application No. 202210189357.3, filed with the China National Intellectual Property Administration on Mar. 1, 2022 and entitled “Method and device for pelvic registration, computer-readable storage medium and processor”, which is incorporated in its entirety herein by reference.

### TECHNICAL FIELD

The disclosure relates to the technical field of pelvic registration, and particularly relates to a method and device for pelvic registration, a computer-readable storage medium and a processor.

### BACKGROUND

Medical surgical robot vision navigation is generally used in applications requiring high precision and accuracy. In orthopedic arthroplasty and other robot-assisted or fully autonomous surgery, pelvic registration is one of the links having a relatively significant impact on accuracy of the surgery, especially in hip arthroplasty. During the surgery, an actual bone of a patient is registered with a corresponding virtual or computer bone model, so as to associate a pose of an actual physical bone with the virtual bone model. The pose of the bone includes a position and a rotational orientation of the bone. In this way, actual operation by a doctor on a physiological bone of the patient during the surgery can be accurately guided through preoperative planning on the virtual bone model, thereby reducing a surgical risk. Due to a complex geometry of the pelvis, especially a spherical concave structure of an acetabulum, three-dimensional point cloud registration of the pelvis during the surgery is challenging. Although some methods for patient pelvic registration are available in the art, a registration method which can reduce registration time and guarantee registration accuracy improvement is required in the art.

On account of its own features and a constraint of an objective function, a traditional common iterative closest point (ICP) algorithm is often trapped in a local optimal solution but loses an optimal solution because of influences caused by noise data and bad point pairs on information. Thus, under a complex intraoperative working condition, a registration result of a point set poor in point collection quality is likely to deviate considerably. Moreover, registration failure not only imposes a heavy psychological burden on a surgeon in an intraoperative high-pressure environment, but also causes hidden dangers to guidance of surgical precision by a system, which leads to surgical failure and even accidents.

Therefore, it is required in the art to eliminate or reduce influences of noise and bad point pair data on a registration algorithm, get rid of local optimization during computation through the ICP algorithm as much as possible to obtain an optimal solution, and optimize the ICP algorithm for intraoperative pelvic registration.

The above information disclosed in the background art is only intended to enhance understanding of the background art of techniques described herein, and therefore the background art may contain certain information that does not form the prior art known in China to those skilled in the art.

### SUMMARY

A main objective of the disclosure is to provide a method and device for pelvic registration, a computer-readable storage medium and a processor, so as to solve the problem of big error in pelvic registration in the prior art.

An aspect of an example of the disclosure provides a method for pelvic registration. The method includes: a primary registration step is executed, wherein a primary registration model and a primary registration matrix are obtained by registering a three-dimensional model of a pelvis with an actual pelvis according to M first marker points, where the first marker point is any point of the pelvis, at least three first marker points are not located on the same straight line, and M≥3; a secondary registration step is executed, wherein a secondary registration model and a secondary registration matrix are obtained by registering the primary registration model with the actual pelvis according to N second marker points, where the second marker point is any point of the pelvis, and N>M; a point deletion step is executed, wherein second marker points having first registration errors greater than an error threshold are deleted and remaining second marker points are determined as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model; a tertiary registration step is executed, wherein a tertiary registration model and a tertiary registration matrix are obtained by registering the primary registration model with the actual pelvis according to the plurality of third marker points; a first determination step is executed, wherein an optimized registration matrix is determined according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, and the third distance is a distance between a corresponding point of the second marker point in the tertiary registration model and a corresponding point of the predetermined point in the tertiary registration model; and a second determination step is executed, wherein a registration model corresponding to the optimized registration matrix is determined as an optimized registration model.

Alternatively, an optimized registration matrix is determined according to a mean of first registration errors and a mean of second registration errors includes: a first registration error matrix is obtained through an iterative closest point algorithm, where the first registration error matrix includes N first registration errors, and the predetermined point is another second marker point closest to the second marker point; a second registration error matrix is obtained through the iterative closest point algorithm, where the second registration error matrix includes N second registration errors; and an optimized registration error matrix and the optimized registration matrix are determined according to the first registration error matrix and the second registration error matrix, where the optimized registration error matrix is a matrix having a less mean of matrix elements of the first registration error matrix and the second registration error matrix, and the optimized registration matrix is a registration matrix corresponding to the optimized registration error matrix

Alternatively, an optimized registration matrix is determined according to a mean of first registration errors and a mean of second registration errors includes: in cases that all first target differences are less than or equal to a difference threshold and all second registration errors corresponding to the third marker points are less than or equal to an error threshold, a matrix having a less mean of matrix elements of the first registration error matrix and the second registration error matrix is determined as the optimized registration error matrix, and a matrix corresponding to the optimized registration error matrix in the secondary registration matrix and the tertiary registration matrix is determined as the optimized registration matrix, where the first target difference is a difference between the second registration error corresponding to the third marker point and the second registration error corresponding to the deleted second marker point; and in at least one of cases that any first target difference is greater than the difference threshold and the second registration error corresponding to any third marker point is greater than an error threshold, all third marker points having differences greater than the difference threshold and all third marker points having second registration errors greater than the error threshold are deleted, remaining third marker points are determined as Xth marker points, where X is greater than 3, an X-ary registration model and an X-ary registration matrix are obtained by re-registering the primary registration model with the actual pelvis according to the Xth marker point, an (X−1)th registration error matrix is obtained by executing computation through the iterative closest point algorithm, where the (X−1)th registration error matrix includes a plurality of (X−1)th registration errors, the (X−1)th registration error is a root mean square error of a (2X−3)th distance and a (2X−2)th distance, the (2X−3)th distance is a distance between the Xth marker point and an (X−1)th predetermined point, and the (2X−2)th distance is a distance between a corresponding point of the Xth marker point in the X-ary registration model and a corresponding point of the (X−1)th predetermined point in the X-ary registration model, point deletion and registration steps are repeated until a first case or a second case occurs, where the first case is that all second target differences are less than or equal to the difference threshold and all the (X−1)th registration errors are less than or equal to the error threshold, and the second case is that the quantity of all the deleted points is greater than or equal to a predetermined quantity, a matrix having a minimum mean of matrix elements of the first registration error matrix, the second registration error matrix and all (X−1)th registration error matrices is determined as the optimized registration error matrix, and a matrix corresponding to the optimized registration error matrix in the secondary registration matrix, the tertiary registration matrix and all X-ary registration matrices is determined as the optimized registration matrix, where the second target difference is a difference between the Xth registration error corresponding to the (X−1)th marker point and an (X−2)th registration error corresponding to the (X−1)th deleted marker point.

Alternatively, after a registration model corresponding to the optimized registration matrix is determined as an optimized registration model, the method further includes: a rotation model is obtained by rotating the optimized registration model around a rotation axis by a predetermined angle, where the predetermined angle is any angle from −180° to 180°; the primary registration model is updated to the rotation model; the secondary registration step, the point deletion step, the tertiary registration step, the first determination step and the second determination step are repeated to obtain an optimized registration error matrix and an optimized registration model corresponding to the predetermined angle; and a target rotation angle is determined according to optimized registration error matrices corresponding to a plurality of predetermined angles, where the target rotation angle is the predetermined angle corresponding to the optimized registration error matrix having a minimum mean of matrix elements of the optimized registration error matrices corresponding to the plurality of predetermined angles.

Alternatively, a target rotation angle is determined according to optimized registration error matrices corresponding to a plurality of predetermined angles includes: a preliminary registration model is determined according to the optimized registration error matrices corresponding to −180° and a plurality of first predetermined angles spaced from each other by a first interval angle, where the preliminary registration model is the optimized registration model corresponding to a preferred angle of the optimized registration error matrix having a minimum mean of matrix elements of the optimized registration error matrices corresponding to −180° and the first predetermined angles, a difference between a minimum first predetermined angle and −180° is less than or equal to the first interval angle, and a difference between 180° and a maximum first predetermined angle is less than or equal to the first interval angle; and the target rotation angle is determined according to the optimized registration error matrices corresponding to a minimum angle, a maximum angle and a plurality of second predetermined angles spaced from each other by a second interval angle, where the target rotation angle is the second predetermined angle corresponding to the optimized registration error matrix having a minimum mean of matrix elements of the optimized registration error matrices corresponding to the minimum angle, the maximum angle and the second predetermined angle, the second interval angle is less than the first interval angle, the minimum angle is a difference between the preferred angle and the first interval angle, and the maximum angle is the sum of the preferred angle and the first interval angle.

Alternatively, rotation axes include a first straight line, a second straight line and a third straight line, any two of the first straight line, the second straight line and the third straight line are perpendicular to each other, and the rotation axes correspond to the target rotation angles in a one-to-one correspondence manner.

Alternatively, after the target rotation angle is determined according to the optimized registration error matrices corresponding to a minimum angle, a maximum angle and a plurality of second predetermined angles spaced from each other by a second interval angle, the method further includes: three rotation matrices are determined according to three target rotation angles; three projection transformation matrices are determined according to the three rotation matrices and a target pose matrix, where the target pose matrix is a pose matrix of an acetabulum when an acetabular cup is implanted during preoperative planning; the secondary registration matrix is updated to the projection transformation matrix; the point deletion step, the tertiary registration step, the first determination step and the second determination step are repeated to obtain three optimized registration error matrices and three optimized registration models; and an optimal registration error matrix and an optimal registration model are determined according to the three optimized registration error matrices and the three optimal registration models, where the optimal registration error matrix is a matrix having a minimum mean of matrix elements and a variance of the matrix elements less than a variance threshold of the three optimized registration error matrices, and the optimal registration model is a registration model corresponding to the optimized registration error matrix.

Alternatively, an optimized registration matrix is determined according to a mean of first registration errors and a mean of second registration errors includes: a deviation function is established, where the deviation function is used for computing the sum of a collection error and a point cloud error, the collection error is the sum of registration errors of collection points, the collection point is any one of the first marker point, the second marker point and the third marker point, and the point cloud error is the sum of distances between the registration model and points obtained after points of the actual pelvis are subjected to registration matrix transformation; a first deviation is computed according to the secondary registration model, the secondary registration matrix and the deviation function, where the first deviation is the sum of a first collection error and a first point cloud error, the first collection error is the sum of the first registration errors of the second marker points, and the first point cloud error is the sum of distances between the secondary registration model and points obtained after points of the actual pelvis are subjected to secondary registration matrix transformation; a second deviation is computed according to the tertiary registration model, the tertiary registration matrix and the deviation function, where the second deviation is the sum of a second collection error and a second point cloud error, the second collection error is the sum of the second registration errors of the third marker points, and the second point cloud error is the sum of distances between the tertiary registration model and points obtained after points of the actual pelvis are subjected to tertiary registration matrix transformation; and the optimized registration matrix is determined according to the first deviation and the second deviation, where the optimized registration matrix is a registration matrix corresponding to a less one of the first deviation and the second deviation.

Another aspect of an example of the disclosure further provides a device for pelvic registration. The device includes: a first processing unit configured to execute a primary registration step of registering a three-dimensional model of a pelvis with an actual pelvis according to M first marker points to obtain a primary registration model and a primary registration matrix, where the first marker point is any point of the pelvis, at least three first marker points are not located on the same straight line, and M≥3; a second processing unit configured to execute a secondary registration step of registering the primary registration model with the actual pelvis according to N second marker points to obtain a secondary registration model and a secondary registration matrix, where the second marker point is any point of the pelvis, and N>M; a third processing unit configured to execute a point deletion step of deleting second marker points having first registration errors greater than an error threshold and determining remaining second marker points as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model; a fourth processing unit configured to execute a tertiary registration step of registering the primary registration model with the actual pelvis according to the plurality of third marker points to obtain a tertiary registration model and a tertiary registration matrix; a first determination unit configured to execute a first determination step of determining an optimized registration matrix according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, and the third distance is a distance between a corresponding point of the second marker point in the tertiary registration model and a corresponding point of the predetermined point in the tertiary registration model; and a second determination unit configured to execute a second determination step of determining a registration model corresponding to the optimized registration matrix as an optimized registration model.

Yet another aspect of an example of the disclosure further provides a computer-readable storage medium. The computer-readable storage medium includes a stored program, and the program executes any one of the methods.

Still another aspect of an example of the disclosure further provides a processor. The processor is configured to run a program, and the program executes any one of the methods when run.

In an example of the disclosure, in the method for pelvic registration, firstly, a primary registration step is executed, wherein a primary registration model and a primary registration matrix are obtained by registering a three-dimensional model of a pelvis with an actual pelvis according to M first marker points, where the first marker point is any point of the pelvis, at least three first marker points are not located on the same straight line, and M≥3; Then, a secondary registration step is executed, wherein a secondary registration model and a secondary registration matrix are obtained by registering the primary registration model with the actual pelvis according to N second marker points, where the second marker point is any point of the pelvis, and N>M. A point deletion step is executed, wherein second marker points having first registration errors greater than an error threshold are deleted and remaining second marker points are determined as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model. A tertiary registration step is executed, wherein a tertiary registration model and a tertiary registration matrix are obtained by registering the primary registration model with the actual pelvis according to the plurality of third marker points. A first determination step is executed, wherein an optimized registration matrix is determined according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, and the third distance is a distance between a corresponding point of the second marker point in the tertiary registration model and a corresponding point of the predetermined point in the tertiary registration model. Finally, a second determination step is executed, wherein a registration model corresponding to the optimized registration matrix is determined as an optimized registration model. In the method, after primary registration and secondary registration, tertiary registration is executed by deleting points having big registration errors, a registration error matrix is obtained through computation, a registration matrix and a registration model corresponding to the registration error matrix having a minimum error mean are determined as an optimized registration matrix and an optimized registration model by comparing registration error matrices of secondary registration and tertiary registration, registration accuracy is improved by deleting influences of bad point pairs and noise points on operation, and the problem of big errors of pelvic registration in the prior art is solved.

### BRIEF DESCRIPTION OF THE DRAWINGS

Accompanying drawings of the description constitute part of the disclosure and serve to provide further understanding of the disclosure, and illustrative examples of the disclosure and the description of the illustrative examples serve to explain the disclosure and are not to be construed as unduly limiting the disclosure. In the accompanying drawings:

FIG. 1 shows a flow diagram of a method for pelvic registration according to an example of the disclosure; and

FIG. 2 shows a schematic diagram of a device for pelvic registration according to an example of the disclosure.

### DETAILED DESCRIPTION OF THE EMBODIMENTS

It should be noted that examples of the disclosure and the features in the examples can be combined with each other without conflict. The disclosure will be described in detail below with reference to accompanying drawings and in combination with examples.

In order to enable those skilled in the art to better understand the solutions of the disclosure, the technical solutions in examples of the disclosure will be described below clearly and comprehensively in combination with accompanying drawings in the examples of the disclosure. Apparently, the examples described are merely some examples rather than all examples. On the basis of examples of the disclosure, all other examples obtained by those of ordinary skill in the art without making inventive efforts should all fall within the scope of protection of the disclosure.

It should be noted that terms “first”, “second” and so forth in the description and claims of the disclosure and in the above accompanying drawings are used to distinguish between similar objects and not necessarily to describe a particular order or sequential order. It should be understood that data used in this way can be interchanged where appropriate, so as to conveniently describe examples of the disclosure. Moreover, terms “include”, “comprise” and “have” as well as their any variations are intended to cover non-exclusive inclusion, for example, a process, method, system, product or apparatus including a series of steps or units is not required to be limited by those explicitly listed, but can include other steps or units not explicitly listed or inherent to the process, method, product or apparatus.

It should be understood that in the situation that an element (for example, a layer, film, region or substrate) is described as being “on” another element, the element can be directly on another element or an intervening element can be present. Furthermore, in the description and claims, in the situation that an element is described as being “connected” to another element, the element can be “directly connected” to another element or “connected” to another element by means of a third element.

As mentioned in the background art, there is a big errors of pelvic registration in the prior art. In order to solve the above problem, in typical embodiments of the disclosure, a method and device for pelvic registration, a computer-readable storage medium and a processor are provided.

According to an example of the disclosure, a method for pelvic registration is provided.

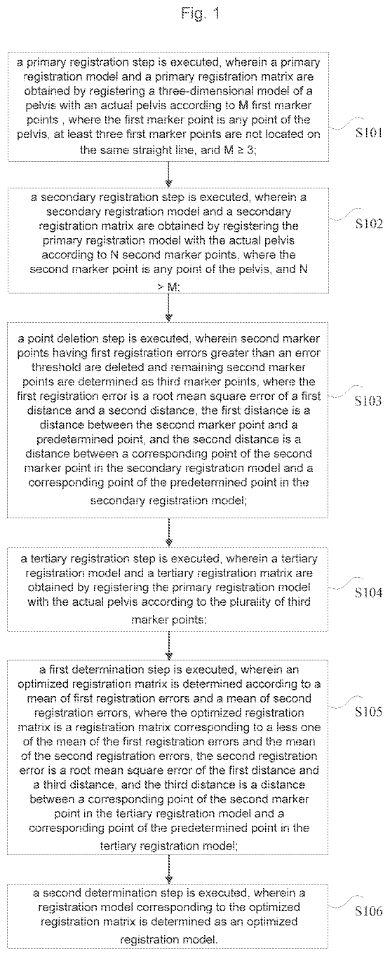

FIG. 1 shows a flow diagram of a method for pelvic registration according to an example of the disclosure. As shown in FIG. 1, the method includes steps as follows:
step S101: a primary registration step is executed, wherein a primary registration model and a primary registration matrix are obtained by registering a three-dimensional model of a pelvis with an actual pelvis according to M first marker points, where the first marker point is any point of the pelvis, at least three first marker points are not located on the same straight line, and M≥3;
step S102: a secondary registration step is executed, wherein a secondary registration model and a secondary registration matrix are obtained by registering the primary registration model with the actual pelvis according to N second marker points, where the second marker point is any point of the pelvis, and N>M;
step S103: a point deletion step is executed, wherein second marker points having first registration errors greater than an error threshold are deleted and remaining second marker points are determined as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model;
step S104: a tertiary registration step is executed, wherein a tertiary registration model and a tertiary registration matrix are obtained by registering the primary registration model with the actual pelvis according to the plurality of third marker points;
step S105: a first determination step is executed, wherein an optimized registration matrix is determined according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, and the third distance is a distance between a corresponding point of the second marker point in the tertiary registration model and a corresponding point of the predetermined point in the tertiary registration model; and
step S106: a second determination step is executed, wherein a registration model corresponding to the optimized registration matrix is determined as an optimized registration model.

In the method for pelvic registration, firstly, a primary registration step is executed, wherein a primary registration model and a primary registration matrix are obtained by registering a three-dimensional model of a pelvis with an actual pelvis according to M first marker points, where the first marker point is any point of the pelvis, at least three first marker points are not located on the same straight line, and M≥3; Then, a secondary registration step is executed, wherein a secondary registration model and a secondary registration matrix are obtained by registering the primary registration model with the actual pelvis according to N second marker points, where the second marker point is any point of the pelvis, and N>M. A point deletion step is executed, wherein second marker points having first registration errors greater than an error threshold are deleted and remaining second marker points are determined as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model. A tertiary registration step is executed, wherein a tertiary registration model and a tertiary registration matrix are obtained by registering the primary registration model with the actual pelvis according to the plurality of third marker points. A first determination step is executed, wherein an optimized registration matrix is determined according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, and the third distance is a distance between a corresponding point of the second marker point in the tertiary registration model and a corresponding point of the predetermined point in the tertiary registration model. Finally, a second determination step is executed, wherein a registration model corresponding to the optimized registration matrix is determined as an optimized registration model. In the method, after primary registration and secondary registration, tertiary registration is executed by deleting points having big registration errors, a registration error matrix is obtained through computation, a registration matrix and a registration model corresponding to the registration error matrix having a minimum error mean are determined as an optimized registration matrix and an optimized registration model by comparing registration error matrices of secondary registration and tertiary registration, registration accuracy is improved by deleting influences of bad point pairs and noise points on operation, and the problem of big errors of pelvic registration in the prior art is solved.

It should be noted that the primary registration step is coarse registration. Generally, 3-5 anatomical landmark point locations, for example, an anterior edge of an acetabulum, a posterior edge of the acetabulum, and a lowest edge of a horseshoe fossa, of the acetabulum of a patient during surgery, and point pairs having the same quantity as corresponding point locations of a virtual reconstructed bone displayed in a system during preoperative planning are selected. A corresponding initial intraoperative and virtual modeling coordinate transformation matrix, that is, primary registration matrix Tc, may be obtained through a coarse registration algorithm such as Landmark. The secondary registration step and the tertiary registration step are fine registration. Generally, 20-48 points near the acetabulum, for example, the horseshoe fossa, a facies lunata, a labium externum of the acetabulum and an exterior edge of the acetabulum are collected to form a fine registration point set to be used for correcting errors caused by projection during coarse registration. Registration is carried out through a vtk_ICP algorithm to obtain corresponding secondary registration matrix Ti and tertiary registration matrix Td.

It should be noted that steps shown in the flow diagram of accompanying drawings can be executed in a computer system such as a set of computer-executable instructions, and although a logical order is shown in the flow diagram, in some situations, the steps shown or described can be executed in an order different from that herein.

In an example of the disclosure, an optimized registration matrix is determined according to a mean of first registration errors and a mean of second registration errors includes: a first registration error matrix is obtained through an iterative closest point algorithm, where the first registration error matrix includes N first registration errors, and the predetermined point is another second marker point closest to the second marker point; a second registration error matrix is obtained through the iterative closest point algorithm, where the second registration error matrix includes N second registration errors; and an optimized registration error matrix and the optimized registration matrix are determined according to the first registration error matrix and the second registration error matrix, where the optimized registration error matrix is a matrix having a less mean of matrix elements of the first registration error matrix and the second registration error matrix, and the optimized registration matrix is a registration matrix corresponding to the optimized registration error matrix. Specifically, the second marker point and the predetermined point are projected onto a point cloud corresponding to the secondary registration model through Tc*Ti, that is, coordinates of the corresponding points of the second marker point and the predetermined point may be computed according to coordinates of the second marker point and the predetermined point, so as to compute the first distance and the second distance to obtain the first registration error, and N first registration errors form the first registration error matrix. The second marker point and the predetermined point are projected onto a point cloud corresponding to the tertiary registration model through Tc*Td, that is, coordinates of corresponding points of the second marker point and the predetermined point are computed according to coordinates of the second marker point and the predetermined point, so as to compute a third distance to obtain the second registration error, and N second registration errors form the second registration error matrix. That is, a mean of matrix elements of the first registration error matrix and a mean of matrix elements of the second registration error matrix may be computed, a matrix having a less mean of matrix elements is determined as an optimized registration error matrix, and a registration matrix corresponding to the optimized registration error matrix is determined as the optimized registration matrix.

It should be noted that the error threshold may be taken from a mean, a median, a mode, a maximum value/2 or an (n/3)th value of the N first registration errors, where n/3 is an integer. According to data distribution features and statistical laws, one of the above values is used as an index, the index is compared with a statistical empirical value (for example, 1 mm) of system registration accuracy, scaling is carried out in a proportional interval of [0, 1], and a greater one of the two values is taken as the error threshold for deleted points.

In an example of the disclosure, an optimized registration matrix is determined according to a mean of first registration errors and a mean of second registration errors includes: in cases that all first target differences are less than or equal to a difference threshold and all second registration errors corresponding to the third marker points are less than or equal to an error threshold, a matrix having a less mean of matrix elements of the first registration error matrix and the second registration error matrix is determined as the optimized registration error matrix, and a matrix corresponding to the optimized registration error matrix in the secondary registration matrix and the tertiary registration matrix is determined as the optimized registration matrix, where the first target difference is a difference between the second registration error corresponding to the third marker point and the second registration error corresponding to the deleted second marker point; and in at least one of cases that any first target difference is greater than the difference threshold and the second registration error corresponding to any third marker point is greater than an error threshold, all third marker points having differences greater than the difference threshold and all third marker points having second registration errors greater than the error threshold are deleted, remaining third marker points are determined as Xth marker points, where X is greater than 3, an X-ary registration model and an X-ary registration matrix are obtained by re-registering the primary registration model with the actual pelvis according to the Xth marker point, an (X−1)th registration error matrix is obtained by executing computation through the iterative closest point algorithm, where the (X−1)th registration error matrix includes a plurality of (X−1)th registration errors, the (X−1)th registration error is a root mean square error of a (2X−3)th distance and a (2X−2)th distance, the (2X−3)th distance is a distance between the Xth marker point and an (X−1)th predetermined point, and the (2X−2)th distance is a distance between a corresponding point of the Xth marker point in the X-ary registration model and a corresponding point of the (X−1)th predetermined point in the X-ary registration model, point deletion and registration steps are repeated until a first case or a second case occurs, where the first case is that all second target differences are less than or equal to the difference threshold and all the (X−1)th registration errors are less than or equal to the error threshold, and the second case is that the quantity of all the deleted points is greater than or equal to a predetermined quantity, a matrix having a minimum mean of matrix elements of the first registration error matrix, the second registration error matrix and all (X−1)th registration error matrices is determined as the optimized registration error matrix, and a matrix corresponding to the optimized registration error matrix in the secondary registration matrix, the tertiary registration matrix and all X-ary registration matrices is determined as the optimized registration matrix, where the second target difference is a difference between the Xth registration error corresponding to the (X−1)th marker point and an (X−2)th registration error corresponding to the (X−1)th deleted marker point. Specifically, the third marker points are second marker points not deleted, and in cases that all the first target differences are less than or equal to the difference threshold and the second registration errors corresponding to all the third marker points are less than or equal to the error threshold, it is proved that it is effective to improve registration accuracy by carrying out registration by deleting points through an ICP algorithm. Otherwise, it is indicated that in the second registration error matrix, there is a second registration error of the third marker point greater than a second registration error of a deleted second marker point, and the difference is greater than the difference threshold, or there is a second registration error of the third marker point greater than the error threshold, which proves that it is not effective to improve registration accuracy by carrying out registration by deleting points through an ICP algorithm, and it is required to carry out registration again by deleting points. All third marker points having differences greater than the difference threshold and all third marker points having second registration errors greater than the error threshold are deleted, and remaining third marker points are determined as Xth marker points such that point deletion and registration steps may be repeated until all the second target differences are less than or equal to the difference threshold and all (X−1)th registration errors are less than or equal to the error threshold, or the quantity of all the deleted points is greater than or equal to a predetermined quantity. A matrix having a minimum mean of matrix elements of all the registration error matrices is determined as the optimized registration error matrix, and a matrix corresponding to the optimized registration error matrix in the secondary registration matrix, the tertiary registration matrix, and all X-ary registration matrices is determined as the optimized registration matrix.

It should be noted that in the point deletion step, all third marker points having differences greater than the difference threshold and all third marker points having second registration errors greater than the error threshold are deleted, and remaining third marker points are retained. Alternatively, all third marker points having differences greater than the difference threshold and all second marker points having second registration errors greater than the error threshold are deleted from the second marker points, and remaining second marker points are retained.

In an example of the disclosure, after a registration model corresponding to the optimized registration matrix is determined as an optimized registration model, the method further includes: a rotation model is obtained by rotating the optimized registration model around a rotation axis by a predetermined angle, where the predetermined angle is any angle from −180° to 180°; the primary registration model is updated to the rotation model; the secondary registration step, the point deletion step, the tertiary registration step, the first determination step and the second determination step are repeated to obtain an optimized registration error matrix and an optimized registration model corresponding to the predetermined angle; and a target rotation angle is determined according to optimized registration error matrices corresponding to a plurality of predetermined angles, where the target rotation angle is the predetermined angle corresponding to the optimized registration error matrix having a minimum mean of matrix elements of the optimized registration error matrices corresponding to the plurality of predetermined angles. Specifically, the primary registration model is rotated around a rotation axis to obtain rotation models every predetermined angle from −180°-180°, the primary registration model is updated to the rotation model, and the secondary registration step, the point deletion step, the tertiary registration step, the first determination step and the second determination step are executed once to obtain a plurality of the optimized registration error matrices. The predetermined angle corresponding to the optimized registration error matrix having a minimum mean of matrix elements is determined as the target rotation angle, and an initial position of a point set to be registered is changed by rotating the registration model around the rotation axis in three-dimensional space. Therefore, the situation that the ICP algorithm for registration used in the current intraoperative pelvic registration is likely to be limited to local optima, such that the algorithm loses an optimal solution and obtains a sub-optimal solution is reduced or avoided, and registration accuracy of intraoperative clinical practice is improved and enhanced.

In an example of the disclosure, a target rotation angle is determined according to optimized registration error matrices corresponding to a plurality of predetermined angles includes: a preliminary registration model is determined according to the optimized registration error matrices corresponding to −180° and a plurality of first predetermined angles spaced from each other by a first interval angle, where the preliminary registration model is the optimized registration model corresponding to a preferred angle of the optimized registration error matrix having a minimum mean of matrix elements of the optimized registration error matrices corresponding to −180° and the first predetermined angles, a difference between a minimum first predetermined angle and −180° is less than or equal to the first interval angle, and a difference between 180° and a maximum first predetermined angle is less than or equal to the first interval angle; and the target rotation angle is determined according to the optimized registration error matrices corresponding to a minimum angle, a maximum angle and a plurality of second predetermined angles spaced from each other by a second interval angle, where the target rotation angle is the second predetermined angle corresponding to the optimized registration error matrix having a minimum mean of matrix elements of the optimized registration error matrices corresponding to the minimum angle, the maximum angle and the second predetermined angle, the second interval angle is less than the first interval angle, the minimum angle is a difference between the preferred angle and the first interval angle, and the maximum angle is the sum of the preferred angle and the first interval angle. Specifically, the primary registration model is rotated around a rotation axis to obtain first rotation models every first predetermined angle corresponding to first interval angle k° from −180°-180°, the primary registration model is updated to the first rotation model, the secondary registration step, the point deletion step, the tertiary registration step, the first determination step and the second determination step are executed once to obtain a plurality of the optimized registration error matrices, and the first predetermined angle corresponding to the optimized registration error matrix having a minimum mean of matrix elements as preferred angle α. A second rotation model is obtained every second predetermined angle corresponding to second interval angle 1° from minimum angle (α−k)° to maximum angle (α+k)°, the primary registration model is updated to a second rotation model, and the secondary registration step, the point deletion step, the tertiary registration step once, the first determination step and the second determination step are executed to obtain a plurality of optimized registration error matrices. The second predetermined angle corresponding to the optimized registration error matrix having a minimum mean of matrix elements is determined as the target rotation angle, and the target rotation angle is determined by carrying out rotary registration twice, so as to avoid excessive computed angles and reduce a computation quantity.

In an example of the disclosure, rotation axes include a first straight line, a second straight line and a third straight line, any two of the first straight line, the second straight line and the third straight line are perpendicular to each other, and the rotation axes correspond to the target rotation angles in a one-to-one correspondence manner. Specifically, rotation axes include a first straight line, a second straight line and a third straight line, that is, an X axis, a Y axis and a Z axis, the registration model rotates around a coordinate axis in an X-Y-Z coordinate system, and the rotation axes correspond to the target rotation angles in a one-to-one correspondence manner.

In an example of the disclosure, after the target rotation angle is determined according to the optimized registration error matrices corresponding to a minimum angle, a maximum angle and a plurality of second predetermined angles spaced from each other by a second interval angle, the method further includes: three rotation matrices are determined according to three target rotation angles; three projection transformation matrices are determined according to the three rotation matrices and a target pose matrix, where the target pose matrix is a pose matrix of an acetabulum when an acetabular cup is implanted during preoperative planning; the secondary registration matrix is updated to the projection transformation matrix; the point deletion step, the tertiary registration step, the first determination step and the second determination step are repeated to obtain three optimized registration error matrices and three optimized registration models; and an optimal registration error matrix and an optimal registration model are determined according to the three optimized registration error matrices and the three optimal registration models, where the optimal registration error matrix is a matrix having a minimum mean of matrix elements and a variance of the matrix elements less than a variance threshold of the three optimized registration error matrices, and the optimal registration model is a registration model corresponding to the optimized registration error matrix. Specifically, the rotation matrix is determined according to the target rotation angle, for example, the target rotation angles corresponding to the X axis, the Y axis and the Z axis are all θ, the rotation matrix

$${R}_{x} = [ \begin{matrix}1 & 0 & 0 & 0 \\ 0 & cos θ & - sin θ & 0 \\ 0 & sin θ & cos θ & 0 \\ 0 & 0 & 0 & 1\end{matrix} ] ,$$

the rotation matrix

$${R}_{y} = [ \begin{matrix}cos θ & 0 & sin θ & 0 \\ 0 & 1 & 0 & 0 \\ - sin θ & 0 & cos θ & 0 \\ 0 & 0 & 0 & 1\end{matrix} ] ,$$

the rotation matrix

$${R}_{z} = [ \begin{matrix}cos θ & - sin θ & 0 & 0 \\ sin θ & cos θ & 0 & 0 \\ 0 & 0 & 1 & 0 \\ 0 & 0 & 0 & 1\end{matrix} ] ,$$

when registration disturbance rotation is carried out, the pose matrix of the acetabulum when the acetabular cup is implanted during preoperative planning is obtained, and the projection transformation matrix is Tf=C=R_{θ}*C⁻¹, and the secondary registration matrix is updated to the projection transformation matrix; the point deletion step, the tertiary registration step, the first determination step and the second determination step are repeated to obtain three optimized registration error matrices and three optimized registration models, where the optimal registration error matrix is a matrix having a minimum mean of matrix elements and a variance of the matrix elements less than a variance threshold of the three optimized registration error matrices, and the optimal registration model is a registration model corresponding to the optimized registration error matrix.

In an example of the disclosure, an optimized registration matrix is determined according to a mean of first registration errors and a mean of second registration errors includes: a deviation function is established, where the deviation function is used for computing the sum of a collection error and a point cloud error, the collection error is the sum of registration errors of collection points, the collection point is any one of the first marker point, the second marker point and the third marker point, and the point cloud error is the sum of distances between the registration model and points obtained after points of the actual pelvis are subjected to registration matrix transformation; a first deviation is computed according to the secondary registration model, the secondary registration matrix and the deviation function, where the first deviation is the sum of a first collection error and a first point cloud error, the first collection error is the sum of the first registration errors of the second marker points, and the first point cloud error is the sum of distances between the secondary registration model and points obtained after points of the actual pelvis are subjected to secondary registration matrix transformation; a second deviation is computed according to the tertiary registration model, the tertiary registration matrix and the deviation function, where the second deviation is the sum of a second collection error and a second point cloud error, the second collection error is the sum of the second registration errors of the third marker points, and the second point cloud error is the sum of distances between the tertiary registration model and points obtained after points of the actual pelvis are subjected to tertiary registration matrix transformation; and the optimized registration matrix is determined according to the first deviation and the second deviation, where the optimized registration matrix is a registration matrix corresponding to a less one of the first deviation and the second deviation. Specifically, the deviation function is

$$f ( T ) = \text{?} w ( \text{?} ) + \text{?} dist ( S , \text{?} ) , where \text{?} = \vert {P}_{i}^{V} - {TP}_{i}^{S} \vert ,$$

$$w ( \text{?} ) = \{ \begin{matrix}0 & \text{?} < min \\ tol * \frac{\text{?} - min}{tol - min} & min \leq \text{?} < tol \\ \text{?} * exp ( \text{?} - tol ) & else\end{matrix} ,$$

$$\text{?} \text{indicates text missing or illegible when filed}$$

T refers to conversion between a coordinate system of an actual pelvis during surgery and a coordinate system of a registration model, p is the quantity of points of registered marker points, q is the quantity of points of a point cloud of a registration model, [symbol] is a corresponding point of a marker point collected on the actual pelvis on the registration model, [symbol] is a marker point collected on the actual pelvis, S is a point cloud of the registration model, Qⱼ^{S} is a point on the actual pelvis, and dist(S,TQⱼ^{S}) is used to compute a distance from projection point Qⱼ^{S} to registration model S. A penalty function ω(dₜ) is used for computing a distance between point [symbol] in a visible coordinate system of the registration model and corresponding point [symbol] in a coordinate system of an actual pelvis during surgery by adding a linear or exponential penalty term, so as to further optimize a deviation function. Specifically, tol is an error threshold, and min is a minimum value of matrix elements of the registration error matrix. The first deviation is computed through deviation function f (T), so as to determine a registration matrix having a minimum first deviation as the optimized registration matrix, thereby determining the registration model corresponding to the optimized registration matrix as the optimized registration model.

It should be noted that by minimizing deviation function f (T), points having distances less than the error threshold are retained, and a distance error of the points is tolerable. Points having distances greater than the threshold and still carrying certain key information are recalled within a certain range through an exponential function, so as to participate in optimal computation of the deviation function. In combination with the point deletion and rotation methods, the iterative closest point algorithm for registration for intraoperative pelvic registration is optimized and improved. Moreover, the situation that an objective function is likely to be limited to local optima due to influences of local bad point pairs or noise and the ICP algorithm is reduced.

An example of the disclosure further provides a device for pelvic registration, and it should be noted that the device for pelvic registration in an example of the disclosure can be configured to execute the method for pelvic registration provided in an example of the disclosure. The device for pelvic registration provided in an example of the disclosure will be introduced below.

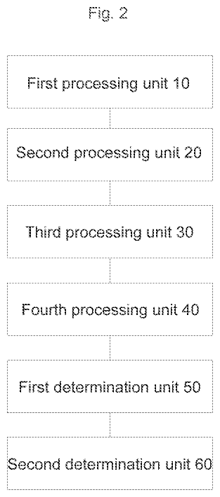

FIG. 2 shows a schematic diagram of a device for pelvic registration according to an example of the disclosure. As shown in FIG. 2, the device includes:
a first processing unit 10 configured to execute a primary registration step of registering a three-dimensional model of a pelvis with an actual pelvis according to M first marker points to obtain a primary registration model and a primary registration matrix, where the first marker point is any point of the pelvis, at least three first marker points are not located on the same straight line, and M≥3;
a second processing unit 20 configured to execute a secondary registration step of registering the primary registration model with the actual pelvis according to N second marker points to obtain a secondary registration model and a secondary registration matrix, where the second marker point is any point of the pelvis, and N>M;
a third processing unit 30 configured to execute a point deletion step of deleting second marker points having first registration errors greater than an error threshold and determining remaining second marker points as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model;
a fourth processing unit 40 configured to execute a tertiary registration step of registering the primary registration model with the actual pelvis according to the plurality of third marker points to obtain a tertiary registration model and a tertiary registration matrix;
a first determination unit 50 configured to execute a first determination step of determining an optimized registration matrix according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, and the third distance is a distance between a corresponding point of the second marker point in the tertiary registration model and a corresponding point of the predetermined point in the tertiary registration model; and
a second determination unit 60 configured to execute a second determination step of determining a registration model corresponding to the optimized registration matrix as an optimized registration model.

In the device for pelvic registration, a first processing unit executes a primary registration step of registering a three-dimensional model of a pelvis with an actual pelvis according to M first marker points to obtain a primary registration model and a primary registration matrix, where the first marker point is any point of the pelvis, at least three first marker points are not located on the same straight line, and M≥3. A second processing unit executes a secondary registration step of registering the primary registration model with the actual pelvis according to N second marker points to obtain a secondary registration model and a secondary registration matrix, where the second marker point is any point of the pelvis, and N>M. A third processing unit executes a point deletion step of deleting second marker points having first registration errors greater than an error threshold and determining remaining second marker points as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model. A fourth processing unit executes a tertiary registration step of registering the primary registration model with the actual pelvis according to the plurality of third marker points to obtain a tertiary registration model and a tertiary registration matrix. A first determination unit executes a first determination step of determining an optimized registration matrix according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, the third distance is a distance between a corresponding point of the second marker point in the tertiary registration model and a corresponding point of the predetermined point in the tertiary registration model, and the fourth distance is a distance between a corresponding point of the third marker point in the tertiary registration model and a corresponding point of the predetermined point in the tertiary registration model. A second determination unit executes a second determination step of determining a registration model corresponding to the optimized registration matrix as an optimized registration model. According to the device, after primary registration and secondary registration, tertiary registration is executed by deleting points having big registration errors, a registration error matrix is obtained through computation, a registration matrix and a registration model corresponding to the registration error matrix having a minimum error mean are determined as an optimized registration matrix and an optimized registration model by comparing registration error matrices of secondary registration and tertiary registration, registration accuracy is improved by deleting influences of bad point pairs and noise points on operation, and the problem of big errors of pelvic registration in the prior art is solved.

It should be noted that the primary registration step is coarse registration. Generally, 3-5 anatomical landmark point locations, for example, an anterior edge of an acetabulum, a posterior edge of the acetabulum, and a lowest edge of a horseshoe fossa, of the acetabulum of a patient during surgery, and point pairs having the same quantity as corresponding point locations of a virtual reconstructed bone displayed in a system during preoperative planning are selected. A corresponding initial intraoperative and virtual modeling coordinate transformation matrix, that is, primary registration matrix Tc, may be obtained through a coarse registration algorithm such as Landmark. The secondary registration step and the tertiary registration step are fine registration. Generally, 20-48 points near the acetabulum, for example, the horseshoe fossa, a facies lunata, a labium externum of the acetabulum and an exterior edge of the acetabulum are collected to form a fine registration point set to be used for correcting errors caused by projection during coarse registration. Registration is carried out through a vtk_ICP algorithm to obtain corresponding secondary registration matrix Ti and tertiary registration matrix Td.

In an example of the disclosure, the first determination unit includes a first computation module, a second computation module and a first determination module. The first computation module is configured to obtain a first registration error matrix through an iterative closest point algorithm, where the first registration error matrix includes N first registration errors, and the predetermined point is another second marker point closest to the second marker point. The second computation module is configured to obtain a second registration error matrix through the iterative closest point algorithm, where the second registration error matrix includes N second registration errors. The first determination module is configured to determine an optimized registration error matrix and the optimized registration matrix according to the first registration error matrix and the second registration error matrix, where the optimized registration error matrix is a matrix having a less mean of matrix elements of the first registration error matrix and the second registration error matrix, and the optimized registration matrix is a registration matrix corresponding to the optimized registration error matrix. Specifically, the second marker point and the predetermined point are projected onto a point cloud corresponding to the secondary registration model through Tc*Ti, that is, coordinates of the corresponding points of the second marker point and the predetermined point may be computed according to coordinates of the second marker point and the predetermined point, so as to compute the first distance and the second distance to obtain the first registration error, and N first registration errors form the first registration error matrix. The second marker point and the predetermined point are projected onto a point cloud corresponding to the tertiary registration model through Tc*Td, that is, coordinates of corresponding points of the second marker point and the predetermined point are computed according to coordinates of the second marker point and the predetermined point, so as to compute a third distance to obtain the second registration error, and N second registration errors form the second registration error matrix. That is, a mean of matrix elements of the first registration error matrix and a mean of matrix elements of the second registration error matrix may be computed, a matrix having a less mean of matrix elements is determined as an optimized registration error matrix, and a registration matrix corresponding to the optimized registration error matrix is determined as the optimized registration matrix.

It should be noted that the error threshold may be taken from a mean, a median, a mode, a maximum value/2 or an (n/3)th value of the N first registration errors, where n/3 is an integer. According to data distribution features and statistical laws, one of the above values is used as an index, the index is compared with a statistical empirical value (for example, 1 mm) of system registration accuracy, scaling is carried out in a proportional interval of [0, 1], and a greater one of the two values is taken as the error threshold for deleted points.

In an example of the disclosure, the first determination unit further includes a second determination module and a first processing module. The second determination module is configured to determine, in cases that all first target differences are less than or equal to a difference threshold and all the second registration errors corresponding to the third marker points are less than or equal to an error threshold, a matrix having a less mean of matrix elements of the first registration error matrix and the second registration error matrix as the optimized registration error matrix, and determine a matrix corresponding to the optimized registration error matrix in the secondary registration matrix and the tertiary registration matrix as the optimized registration matrix, where the first target difference is a difference between the second registration error corresponding to the third marker point and the second registration error corresponding to the deleted second marker point. The first processing module is configured to delete, in at least one of cases that any first target difference is greater than the difference threshold and the second registration error corresponding to any third marker point is greater than an error threshold, all third marker points having differences greater than the difference threshold and all third marker points having second registration errors greater than the error threshold, determine remaining third marker points as Xth marker points, where X is greater than 3, re-register the primary registration model with the actual pelvis according to the Xth marker point to obtain an X-ary registration model and an X-ary registration matrix, execute computation through the iterative closest point algorithm to obtain an (X−1)th registration error matrix, where the (X−1)th registration error matrix includes a plurality of (X−1)th registration errors, the (X−1)th registration error is a root mean square error of a (2X−3)th distance and a (2X−2)th distance, the (2X−3)th distance is a distance between the Xth marker point and an (X−1)th predetermined point, and the (2X−2)th distance is a distance between a corresponding point of the Xth marker point in the X-ary registration model and a corresponding point of the (X−1)th predetermined point in the X-ary registration model, repeat point deletion and registration steps until a first case or a second case occurs, where the first case is that all second target differences are less than or equal to the difference threshold and all the (X−1)th registration errors are less than or equal to the error threshold, and the second case is that the quantity of all the deleted points is greater than or equal to a predetermined quantity, determine a matrix having a minimum mean of matrix elements of the first registration error matrix, the second registration error matrix and all (X−1)th registration error matrices as the optimized registration error matrix, and determine a matrix corresponding to the optimized registration error matrix in the secondary registration matrix, the tertiary registration matrix and all X-ary registration matrices as the optimized registration matrix, where the second target difference is a difference between the Xth registration error corresponding to the (X−1)th marker point and an (X−2)th registration error corresponding to the (X−1)th deleted marker point. Specifically, the third marker points are second marker points not deleted, and in cases that all the first target differences are less than or equal to the difference threshold and the second registration errors corresponding to all the third marker points are less than or equal to the error threshold, it is proved that it is effective to improve registration accuracy by carrying out registration by deleting points through an ICP algorithm. Otherwise, it is indicated that in the second registration error matrix, there is a second registration error of the third marker point greater than a second registration error of a deleted second marker point, and the difference is greater than the difference threshold, or there is a second registration error of the third marker point greater than the error threshold, which proves that it is not effective to improve registration accuracy by carrying out registration by deleting points through an ICP algorithm, and it is required to carry out registration again by deleting points. All third marker points having differences greater than the difference threshold and all third marker points having second registration errors greater than the error threshold are deleted, and remaining third marker points are determined as Xth marker points such that point deletion and registration steps may be repeated until all the second target differences are less than or equal to the difference threshold and all (X−1)th registration errors are less than or equal to the error threshold, or the quantity of all the deleted points is greater than or equal to a predetermined quantity. A matrix having a minimum mean of matrix elements of all the registration error matrices is determined as the optimized registration error matrix, and a matrix corresponding to the optimized registration error matrix in the secondary registration matrix, the tertiary registration matrix, and all X-ary registration matrices is determined as the optimized registration matrix.

It should be noted that in the point deletion step, all third marker points having differences greater than the difference threshold and all third marker points having second registration errors greater than the error threshold are deleted, and remaining third marker points are retained. Alternatively, all third marker points having differences greater than the difference threshold and all second marker points having second registration errors greater than the error threshold are deleted from the second marker points, and remaining second marker points are retained.

In an example of the disclosure, the device further includes a first processing unit, and the first processing unit includes a second processing module, a first update module, a first repetition module and a third determination module. The second processing module is configured to rotate, after the registration model corresponding to the optimized registration matrix is determined as the optimized registration model, the optimized registration model around a rotation axis by a predetermined angle to obtain a rotation model, where the predetermined angle is any angle from −180° to 180°. The first update module is configured to update the primary registration model to the rotation model. The first repetition module is configured to repeat the secondary registration step, the point deletion step, the tertiary registration step, the first determination step and the second determination step to obtain an optimized registration error matrix and an optimized registration model corresponding to the predetermined angle. The third determination module is configured to determine a target rotation angle according to optimized registration error matrices corresponding to a plurality of predetermined angles, where the target rotation angle is the predetermined angle corresponding to the optimized registration error matrix having a minimum mean of matrix elements of the optimized registration error matrices corresponding to the plurality of predetermined angles. Specifically, the primary registration model is rotated around a rotation axis to obtain rotation models every predetermined angle from −180°-180°, the primary registration model is updated to the rotation model, and the secondary registration step, the point deletion step, the tertiary registration step, the first determination step and the second determination step are executed once to obtain a plurality of the optimized registration error matrices. The predetermined angle corresponding to the optimized registration error matrix having a minimum mean of matrix elements is determined as the target rotation angle, and an initial position of a point set to be registered is changed by rotating the registration model around the rotation axis in three-dimensional space. Therefore, the situation that the ICP algorithm for registration used in the current intraoperative pelvic registration is likely to be limited to local optima, such that the algorithm loses an optimal solution and obtains a sub-optimal solution is reduced or avoided, and registration accuracy of intraoperative clinical practice is improved and enhanced.

In an example of the disclosure, the third determination module includes a first determination sub-module and a second determination sub-module. The first determination sub-module is configured to determine a preliminary registration model according to the optimized registration error matrices corresponding to −180° and a plurality of first predetermined angles spaced from each other by a first interval angle, where the preliminary registration model is the optimized registration model corresponding to a preferred angle of the optimized registration error matrix having a minimum mean of matrix elements of the optimized registration error matrices corresponding to −180° and the first predetermined angles, a difference between a minimum first predetermined angle and −180° is less than or equal to the first interval angle, and a difference between 180° and a maximum first predetermined angle is less than or equal to the first interval angle. The second determination sub-module is configured to determine the target rotation angle according to the optimized registration error matrices corresponding to a minimum angle, a maximum angle and a plurality of second predetermined angles spaced from each other by a second interval angle, where the target rotation angle is the second predetermined angle corresponding to the optimized registration error matrix having a minimum mean of matrix elements of the optimized registration error matrices corresponding to the minimum angle, the maximum angle and the second predetermined angle, the second interval angle is less than the first interval angle, the minimum angle is a difference between the preferred angle and the first interval angle, and the maximum angle is the sum of the preferred angle and the first interval angle. Specifically, the primary registration model is rotated around a rotation axis to obtain first rotation models every first predetermined angle corresponding to first interval angle k° from −180°-180°, the primary registration model is updated to the first rotation model, the secondary registration step, the point deletion step, the tertiary registration step, the first determination step and the second determination step are executed once to obtain a plurality of the optimized registration error matrices, and the first predetermined angle corresponding to the optimized registration error matrix having a minimum mean of matrix elements as preferred angle α. A second rotation model is obtained every second predetermined angle corresponding to second interval angle 1° from minimum angle (α−k)° to maximum angle (α+k)°, the primary registration model is updated to a second rotation model, and the secondary registration step, the point deletion step, the tertiary registration step once, the first determination step and the second determination step are executed to obtain a plurality of optimized registration error matrices. The second predetermined angle corresponding to the optimized registration error matrix having a minimum mean of matrix elements is determined as the target rotation angle, and the target rotation angle is determined by carrying out rotary registration twice, so as to avoid excessive computed angles and reduce a computation quantity.

In an example of the disclosure, rotation axes include a first straight line, a second straight line and a third straight line, any two of the first straight line, the second straight line and the third straight line are perpendicular to each other, and the rotation axes correspond to the target rotation angles in a one-to-one correspondence manner. Specifically, rotation axes include a first straight line, a second straight line and a third straight line, that is, an X axis, a Y axis and a Z axis, the registration model rotates around a coordinate axis in an X-Y-Z coordinate system, and the rotation axes correspond to the target rotation angles in a one-to-one correspondence manner.

In an example of the disclosure, the device further includes a second processing unit, and the second processing unit includes a fourth determination module, a fifth determination module, a second update module, a second repetition module and a sixth determination module. The fourth determination module is configured to determine, after the target rotation angle is determined according to the optimized registration error matrices corresponding to a minimum angle, a maximum angle and a plurality of second predetermined angles spaced from each other by a second interval angle, three rotation matrices according to three target rotation angles. The fifth determination module is configured to determine three projection transformation matrices according to the three rotation matrices and a target pose matrix, where the target pose matrix is a pose matrix of an acetabulum when an acetabular cup is implanted during preoperative planning. The second update module is configured to update the secondary registration matrix to the projection transformation matrix. The second repetition module is configured to repeat the point deletion step, the tertiary registration step, the first determination step and the second determination step to obtain three optimized registration error matrices and three optimized registration models. The sixth determination module is configured to determine an optimal registration error matrix and an optimal registration model according to the three optimized registration error matrices and the three optimal registration models, where the optimal registration error matrix is a matrix having a minimum mean of matrix elements and a variance of the matrix elements less than a variance threshold of the three optimized registration error matrices, and the optimal registration model is a registration model corresponding to the optimized registration error matrix. Specifically, the rotation matrix is determined according to the target rotation angle, for example, the target rotation angles corresponding to the X axis, the Y axis and the Z axis are all θ, the rotation matrix

$${R}_{x} = [ \begin{matrix}1 & 0 & 0 & 0 \\ 0 & cos θ & - sin θ & 0 \\ 0 & sin θ & cos θ & 0 \\ 0 & 0 & 0 & 1\end{matrix} ] ,$$

the rotation matrix

$${R}_{y} = [ \begin{matrix}cos θ & 0 & sin θ & 0 \\ 0 & 1 & 0 & 0 \\ - sin θ & 0 & cos θ & 0 \\ 0 & 0 & 0 & 1\end{matrix} ] ,$$

the rotation matrix

$${R}_{z} = [ \begin{matrix}cos θ & - sin θ & 0 & 0 \\ sin θ & cos θ & 0 & 0 \\ 0 & 0 & 1 & 0 \\ 0 & 0 & 0 & 1\end{matrix} ] ,$$

when registration disturbance rotation is carried out, the pose matrix of the acetabulum when the acetabular cup is implanted during preoperative planning is obtained, and the projection transformation matrix is Tf=C*R_{θ}*C⁻¹, and the secondary registration matrix is updated to the projection transformation matrix; and the point deletion step, the tertiary registration step, the first determination step and the second determination step are repeated to obtain three optimized registration error matrices and three optimized registration models, where the optimal registration error matrix is a matrix having a minimum mean of matrix elements and a variance of the matrix elements less than a variance threshold of the three optimized registration error matrices, and the optimal registration model is a registration model corresponding to the optimized registration error matrix.

In an example of the disclosure, the first determination unit includes an establishment module, a third computation module, a fourth computation module and a seventh determination module. The establishment module is configured to establish a deviation function, where the deviation function is used for computing the sum of a collection error and a point cloud error, the collection error is the sum of registration errors of collection points, the collection point is any one of the first marker point, the second marker point and the third marker point, and the point cloud error is the sum of distances between the registration model and points obtained after points of the actual pelvis are subjected to registration matrix transformation. The third computation module is configured to compute a first deviation according to the secondary registration model, the secondary registration matrix and the deviation function, where the first deviation is the sum of a first collection error and a first point cloud error, the first collection error is the sum of the first registration errors of the second marker points, and the first point cloud error is the sum of distances between the secondary registration model and points obtained after points of the actual pelvis are subjected to secondary registration matrix transformation. The fourth computation module is configured to compute a second deviation according to the tertiary registration model, the tertiary registration matrix and the deviation function, where the second deviation is the sum of a second collection error and a second point cloud error, the second collection error is the sum of the second registration errors of the third marker points, and the second point cloud error is the sum of distances between the tertiary registration model and points obtained after points of the actual pelvis are subjected to tertiary registration matrix transformation. The seventh determination module is configured to determine the optimized registration matrix according to the first deviation and the second deviation, where the optimized registration matrix is a registration matrix corresponding to a less one of the first deviation and the second deviation. Specifically. the deviation function is

$$f ( T ) = \text{?} w ( \text{?} ) + \text{?} dist ( S , \text{?} ) , where$$

$$\text{?} = \vert {P}_{i}^{V} - {TP}_{i}^{S} \vert , w ( \text{?} ) = \{ \begin{matrix}0 & \text{?} < min \\ tol * \frac{\text{?} - min}{tol - min} & min \leq \text{?} < tol \\ \text{?} * exp ( \text{?} - tol ) & else\end{matrix} ,$$

$$\text{?} \text{indicates text missing or illegible when filed}$$

T refers to conversion between a coordinate system of an actual pelvis during surgery and a coordinate system of a registration model, p is the quantity of points of registered marker points, q is the quantity of points of a point cloud of a registration model, [symbol] is a corresponding point of a marker point collected on the actual pelvis on the registration model, [symbol] is a marker point collected on the actual pelvis, S is a point cloud of the registration model, Qⱼ^{S} is a point on the actual pelvis, and dist(S,TQⱼ^{S}) is used to compute a distance from a projection point Qⱼ^{S} to registration model S. A penalty function ω(dₜ) is used for computing a distance between point [symbol] in a visible coordinate system of the registration model and corresponding point [symbol] in a coordinate system of an actual pelvis during surgery by adding a linear or exponential penalty term, so as to further optimize a deviation function. Specifically, tol is an error threshold, and min is a minimum value of matrix elements of the registration error matrix. The first deviation is computed through deviation function f(T), so as to determine a registration matrix having a minimum first deviation as the optimized registration matrix, thereby determining the registration model corresponding to the optimized registration matrix as the optimized registration model.

It should be noted that by minimizing deviation function f(T), points having distances less than the error threshold are retained, and a distance error of the points is tolerable. Points having distances greater than the threshold and still carrying certain key information are recalled within a certain range through an exponential function, so as to participate in optimal computation of the deviation function. In combination with the point deletion and rotation methods, the iterative closest point algorithm for registration for intraoperative pelvic registration is optimized and improved. Moreover, the situation that an objective function is likely to be limited to local optima due to influences of local bad point pairs or noise and the ICP algorithm is reduced.

The device for pelvic registration includes a processor and a memory, the first processing unit, the second processing unit, the third processing unit, the fourth processing unit, the first determination unit, the second determination unit, etc. are all stored in the memory as program units, and the processor executes the program units stored in the memory to implement corresponding functions.

The processor includes a core, and the core calls corresponding program units in the memory. One or more cores can be arranged, and the problem of big errors of pelvic registration in the prior art is solved by adjusting core parameters.

The memory may be a volatile memory, a random access memory (RAM) and a non-volatile memory, etc., such as a read-only memory (ROM) or a flash RAM, in a computer-readable medium, and the memory includes at least one memory chip.

An example of the disclosure provides a computer-readable storage medium. The computer-readable storage medium stores a program, and the program implements the above method when executed by a processor.

An example of the disclosure provides a processor. The processor is configured to run a program, and the program executes the above method when run.

An example of the disclosure provides an apparatus. The apparatus includes a processor, a memory and a program that is stored in the memory and can be run on the processor, and the processor implements at least the following steps when executing the program:
step S101: executed a primary registration step of registering a three-dimensional model of a pelvis with an actual pelvis according to M first marker points to obtain a primary registration model and a primary registration matrix, where the first marker point is any point of the pelvis, at least three first marker points are not located on the same straight line, and M≥3;
step S102: executed a secondary registration step of registering the primary registration model with the actual pelvis according to N second marker points to obtain a secondary registration model and a secondary registration matrix, where the second marker point is any point of the pelvis, and N>M;
step S103: executed a point deletion step of deleting second marker points having first registration errors greater than an error threshold and determining remaining second marker points as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model;
step S104: executed a tertiary registration step of registering the primary registration model with the actual pelvis according to the plurality of third marker points to obtain a tertiary registration model and a tertiary registration matrix;
step S105: executed a first determination step of determining an optimized registration matrix according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, and the third distance is a distance between a corresponding point of the second marker point in the tertiary registration model and a corresponding point of the predetermined point in the tertiary registration model; and
step S106: executed a second determination step of determining a registration model corresponding to the optimized registration matrix as an optimized registration model.

The apparatus herein can be a server, a PC (Personal Computer), a PAD, a mobile phone, etc.

The disclosure further provides a computer program product. The computer program product is suitable for executing a program initialized to have at least the following method steps when executed on a data processing apparatus:
step S101: executed a primary registration step of registering a three-dimensional model of a pelvis with an actual pelvis according to M first marker points to obtain a primary registration model and a primary registration matrix, where the first marker point is any point of the pelvis, at least three first marker points are not located on the same straight line, and M≥3;
step S102: executed a secondary registration step of registering the primary registration model with the actual pelvis according to N second marker points to obtain a secondary registration model and a secondary registration matrix, where the second marker point is any point of the pelvis, and N>M;
step S103: executed a point deletion step of deleting second marker points having first registration errors greater than an error threshold and determining remaining second marker points as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model;
step S104: executed a tertiary registration step of registering the primary registration model with the actual pelvis according to the plurality of third marker points to obtain a tertiary registration model and a tertiary registration matrix;
step S105: executed a first determination step of determining an optimized registration matrix according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, and the third distance is a distance between a corresponding point of the second marker point in the tertiary registration model and a corresponding point of the predetermined point in the tertiary registration model; and
step S106: executed a second determination step of determining a registration model corresponding to the optimized registration matrix as an optimized registration model.

In the above examples of the disclosure, description for each example has its own emphasis, and for the part which is not described in detail in a certain example, reference can be made to relevant description in other examples.

In several examples provided in the disclosure, it should be understood that the disclosed technology can be implemented in other ways. The device example described above is merely illustrative, for example, division of the above units can be division of logical functions, and there can be other division manners during actual implementation. For example, a plurality of units or assemblies can be combined or integrated into another system, or some features can be ignored or not executed. Further, shown or discussed coupling, direct coupling or communication connection between each other can be indirect coupling or communication connection by means of some interfaces, units or modules, and can be in an electrical form or another form.

The above units described as separated components can be physically separated or not, and the components displayed as units can be physical units or not, that is, they can be located at one place or distributed on a plurality of units. Part or all of the units can be selected according to actual requirements to realize the objective of the solution of the example.

In addition, all functional units in each example of the disclosure can be integrated into one processing unit, or can be independently and physically present, or two or more units can be integrated into one unit. The above integrated unit can be implemented in the form of hardware or a software functional unit.

The above integrated unit can be stored in a computer-readable storage medium if implemented in the form of a software functional unit and sold or used as an independent product. On the basis of the understanding, the technical solution of the disclosure can be embodied in the form of a software product in essence or a part contributing to the prior art or all or part of the technical solution, and the computer software product is stored in a computer-readable storage medium and includes several instructions for enabling a computer device (which can be a personal computer, a server or a network device, etc.) to implement all or some of the steps of the methods described in various examples of the disclosure. The foregoing computer-readable storage medium can be a universal serial bus flash disk, a read-only memory (ROM), a random access memory (RAM), a mobile hard disk, a magnetic disk, an optical disk and other media capable of storing program codes.

From the above description, it can be seen that the above examples of the disclosure achieve technical effects as follows:
1) In the method for pelvic registration in the disclosure, firstly, a primary registration step of registering a three-dimensional model of a pelvis with an actual pelvis according to M first marker points to obtain a primary registration model and a primary registration matrix is executed, where the first marker point is any point of the pelvis, at least three first marker points are not located on the same straight line, and M>3. Then, a secondary registration step of registering the primary registration model with the actual pelvis according to N second marker points to obtain a secondary registration model and a secondary registration matrix is executed, where the second marker point is any point of the pelvis, and N>M. A point deletion step of deleting second marker points having first registration errors greater than an error threshold and determining remaining second marker points as third marker points is executed, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model. A tertiary registration step of registering the primary registration model with the actual pelvis according to the plurality of third marker points to obtain a tertiary registration model and a tertiary registration matrix is executed. A first determination step of determining an optimized registration matrix according to a mean of first registration errors and a mean of second registration errors is executed, where the optimized registration matrix is a registration matrix corresponding to a less one of the mean of the first registration errors and the mean of the second registration errors, the second registration error is a root mean square error of the first distance and a third distance, the third distance is a distance between a corresponding point of the second marker point in the tertiary registration model and a corresponding point of the predetermined point in the tertiary registration model, and the fourth distance is a distance between a corresponding point of the third marker point in the tertiary registration model and a corresponding point of the predetermined point in the tertiary registration model. Finally, a second determination step of determining a registration model corresponding to the optimized registration matrix as an optimized registration model is executed. In the method, after primary registration and secondary registration, tertiary registration is executed by deleting points having big registration errors, a registration error matrix is obtained through computation, a registration matrix and a registration model corresponding to the registration error matrix having a minimum error mean are determined as an optimized registration matrix and an optimized registration model by comparing registration error matrices of secondary registration and tertiary registration, registration accuracy is improved by deleting influences of bad point pairs and noise points on operation, and the problem of big errors of pelvic registration in the prior art is solved.
2) In the device for pelvic registration in the disclosure, a first processing unit executes a primary registration step of registering a three-dimensional model of a pelvis with an actual pelvis according to M first marker points to obtain a primary registration model and a primary registration matrix, where the first marker point is any point of the pelvis, at least three first marker points are not located on the same straight line, and M≥3. A second processing unit executes a secondary registration step of registering the primary registration model with the actual pelvis according to N second marker points to obtain a secondary registration model and a secondary registration matrix, where the second marker point is any point of the pelvis, and N>M. A third processing unit executes a point deletion step of deleting second marker points having first registration errors greater than an error threshold and determining remaining second marker points as third marker points, where the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model. A fourth processing unit executes a tertiary registration step of registering the primary registration model with the actual pelvis according to the plurality of third marker points to obtain a tertiary registration model and a tertiary registration matrix. A first determination unit executes a first determination step of determining an optimized registration matrix according to a mean of first registration errors and a mean of second registration errors, where the optimized registration matrix is a registration matrix corresponding to a less one of the mean of the first registration errors and the mean of the second registration errors, the second registration error is a root mean square error of the first distance and a third distance, the third distance is a distance between a corresponding point of the second marker point in the tertiary registration model and a corresponding point of the predetermined point in the tertiary registration model, and the fourth distance is a distance between a corresponding point of the third marker point in the tertiary registration model and a corresponding point of the predetermined point in the tertiary registration model. A second determination unit executes a second determination step of determining a registration model corresponding to the optimized registration matrix as an optimized registration model. According to the device, after primary registration and secondary registration, tertiary registration is executed by deleting points having big registration errors, a registration error matrix is obtained through computation, a registration matrix and a registration model corresponding to the registration error matrix having a minimum error mean are determined as an optimized registration matrix and an optimized registration model by comparing registration error matrices of secondary registration and tertiary registration, registration accuracy is improved by deleting influences of bad point pairs and noise points on operation, and the problem of big errors of pelvic registration in the prior art is solved.

What are mentioned above are merely preferred examples of the disclosure and are not Intended to limit the disclosure, and various changes and modifications can be made on the disclosure by those skilled in the art. Any modifications, equivalent substitutions, improvements, etc. within the spirit and principles of the disclosure are intended to be included within the scope of protection of the disclosure.

What is claimed is:

1. A method for pelvic registration, comprising:
executing a primary registration step of registering a three-dimensional model of a pelvis with an actual pelvis according to M first marker points to obtain a primary registration model and a primary registration matrix, wherein the first marker point is any point of the pelvis, at least three first marker points are not located on the same straight line, and M≥3;
executing a secondary registration step of registering the primary registration model with the actual pelvis according to N second marker points to obtain a secondary registration model and a secondary registration matrix, wherein the second marker point is any point of the pelvis, and N>M;
executing a point deletion step of deleting second marker points having first registration errors greater than an error threshold and determining remaining second marker points as third marker points, wherein the first registration error is a root mean square error of a first distance and a second distance, the first distance is a distance between the second marker point and a predetermined point, and the second distance is a distance between a corresponding point of the second marker point in the secondary registration model and a corresponding point of the predetermined point in the secondary registration model;
executing a tertiary registration step of registering the primary registration model with the actual pelvis according to the plurality of third marker points to obtain a tertiary registration model and a tertiary registration matrix;
executing a first determination step of determining an optimized registration matrix according to a mean of first registration errors and a mean of second registration errors, wherein the optimized registration matrix is a registration matrix corresponding to a less one of the mean of the first registration errors and the mean of the second registration errors, the second registration error is a root mean square error of the first distance and a third distance, and the third distance is a distance between a corresponding point of the second marker point in the tertiary registration model and a corresponding point of the predetermined point in the tertiary registration model; and
executing a second determination step of determining a registration model corresponding to the optimized registration matrix as an optimized registration model.

2. The method according to claim 1, wherein the determining an optimized registration matrix according to a mean of first registration errors and a mean of second registration errors comprises:
obtaining a first registration error matrix through an iterative closest point algorithm, wherein the first registration error matrix comprises N first registration errors, and the predetermined point is another second marker point closest to the second marker point;
obtaining a second registration error matrix through the iterative closest point algorithm, wherein the second registration error matrix comprises N second registration errors; and
determining an optimized registration error matrix and the optimized registration matrix according to the first registration error matrix and the second registration error matrix, wherein the optimized registration error matrix is a matrix having a less mean of matrix elements of the first registration error matrix and the second registration error matrix, and the optimized registration matrix is a registration matrix corresponding to the optimized registration error matrix.

3. The method according to claim 2, wherein the determining an optimized registration matrix according to a mean of first registration errors and a mean of second registration errors comprises:
determining, in cases that all first target differences are less than or equal to a difference threshold and all the second registration errors corresponding to the third marker points are less than or equal to an error threshold, the matrix having a less mean of matrix elements of the first registration error matrix and the second registration error matrix as the optimized registration error matrix, and determining a matrix corresponding to the optimized registration error matrix in the secondary registration matrix and the tertiary registration matrix as the optimized registration matrix, wherein the first target difference is a difference between the second registration error corresponding to the third marker point and the second registration error corresponding to the deleted second marker point; and
deleting, in at least one of cases that any first target difference is greater than the difference threshold and the second registration error corresponding to any third marker point is greater than an error threshold, all third marker points having differences greater than the difference threshold and all third marker points having second registration errors greater than the error threshold, determining remaining third marker points as Xth marker points, wherein X is greater than 3, re-registering the primary registration model with the actual pelvis according to the Xth marker point to obtain an X-ary registration model and an X-ary registration matrix, executing computation through the iterative closest point algorithm to obtain an (X−1)th registration error matrix, wherein the (X−1)th registration error matrix comprises a plurality of (X−1)th registration errors, the (X−1)th registration error is a root mean square error of a (2X−3)th distance and a (2X−2)th distance, the (2X−3)th distance is a distance between the Xth marker point and an (X−1)th predetermined point, and the (2X−2)th distance is a distance between a corresponding point of the Xth marker point in the X-ary registration model and a corresponding point of the (X−1)th predetermined point in the X-ary registration model, repeating the point deletion steps and the tertiary registration step until a first case or a second case occurs, wherein the first case is that all second target differences are less than or equal to the difference threshold and all the (X−1)th registration errors are less than or equal to the error threshold, and the second case is that the quantity of all the deleted points is greater than or equal to a predetermined quantity, determining a matrix having a minimum mean of matrix elements of the first registration error matrix, the second registration error matrix and all (X−1)th registration error matrices as the optimized registration error matrix, and determining a matrix corresponding to the optimized registration error matrix in the secondary registration matrix, the tertiary registration matrix and all X-ary registration matrices as the optimized registration matrix, wherein the second target difference is a difference between the Xth registration error corresponding to the (X−1)th marker point and an (X−2)th registration error corresponding to the (X−1)th deleted marker point.

4. The method according to claim 2, wherein after the determining a registration model corresponding to the optimized registration matrix as an optimized registration model, the method further comprises:
rotating the optimized registration model around a rotation axis by a predetermined angle to obtain a rotation model, wherein the predetermined angle is any angle from −180° to 180°;
updating the primary registration model to the rotation model;
repeating the secondary registration step, the point deletion step, the tertiary registration step, the first determination step and the second determination step to obtain an optimized registration error matrix and an optimized registration model corresponding to the predetermined angle; and
determining a target rotation angle according to optimized registration error matrices corresponding to a plurality of predetermined angles, wherein the target rotation angle is the predetermined angle corresponding to the optimized registration error matrix having a minimum mean of matrix elements of the optimized registration error matrices corresponding to the plurality of predetermined angles.

5. The method according to claim 4, wherein the determining a target rotation angle according to optimized registration error matrices corresponding to a plurality of predetermined angles comprises:
determining a preliminary registration model according to the optimized registration error matrices corresponding to −180° and a plurality of first predetermined angles spaced from each other by a first interval angle, wherein the preliminary registration model is the optimized registration model corresponding to a preferred angle of the optimized registration error matrix having a minimum mean of matrix elements of the optimized registration error matrices corresponding to −180° and the first predetermined angles, a difference between a minimum first predetermined angle and −180° is less than or equal to the first interval angle, and a difference between 180° and a maximum first predetermined angle is less than or equal to the first interval angle; and
determining the target rotation angle according to the optimized registration error matrices corresponding to a minimum angle, a maximum angle and a plurality of second predetermined angles spaced from each other by a second interval angle, wherein the target rotation angle is the second predetermined angle corresponding to the optimized registration error matrix having a minimum mean of matrix elements of the optimized registration error matrices corresponding to the minimum angle, the maximum angle and the second predetermined angle, the second interval angle is less than the first interval angle, the minimum angle is a difference between the preferred angle and the first interval angle, and the maximum angle is the sum of the preferred angle and the first interval angle.

6. The method according to claim 5, wherein rotation axes comprise a first straight line, a second straight line and a third straight line, any two of the first straight line, the second straight line and the third straight line are perpendicular to each other, and the rotation axes correspond to the target rotation angles in a one-to-one correspondence manner.

7. The method according to claim 6, wherein after the determining the target rotation angle according to the optimized registration error matrices corresponding to a minimum angle, a maximum angle and a plurality of second predetermined angles spaced from each other by a second interval angle, the method further comprises:
determining three rotation matrices according to three target rotation angles;
determining three projection transformation matrices according to the three rotation matrices and a target pose matrix, wherein the target pose matrix is a pose matrix of an acetabulum when an acetabular cup is implanted during preoperative planning;
updating the secondary registration matrix to the projection transformation matrix;
repeating the point deletion step, the tertiary registration step, the first determination step and the second determination step to obtain three optimized registration error matrices and three optimized registration models; and
determining an optimal registration error matrix and an optimal registration model according to the three optimized registration error matrices and the three optimized registration models, wherein the optimal registration error matrix is a matrix having a minimum mean of matrix elements and a variance of the matrix elements less than a variance threshold of the three optimized registration error matrices, and the optimal registration model is a registration model corresponding to the optimized registration error matrix.

8. The method according to claim 2, wherein the determining an optimized registration matrix according to a mean of first registration errors and a mean of second registration errors comprises:
establishing a deviation function, wherein the deviation function is used for computing the sum of a collection error and a point cloud error, the collection error is the sum of registration errors of collection points, the collection point is any one of the first marker point, the second marker point and the third marker point, and the point cloud error is the sum of distances between the registration model and points obtained after points of the actual pelvis are subjected to registration matrix transformation;
computing a first deviation according to the secondary registration model, the secondary registration matrix and the deviation function, wherein the first deviation is the sum of a first collection error and a first point cloud error, the first collection error is the sum of the first registration errors of the second marker points, and the first point cloud error is the sum of distances between the secondary registration model and points obtained after points of the actual pelvis are subjected to secondary registration matrix transformation;
computing a second deviation according to the tertiary registration model, the tertiary registration matrix and the deviation function, wherein the second deviation is the sum of a second collection error and a second point cloud error, the second collection error is the sum of the second registration errors of the third marker points, and the second point cloud error is the sum of distances between the tertiary registration model and points obtained after points of the actual pelvis are subjected to tertiary registration matrix transformation; and
determining the optimized registration matrix according to the first deviation and the second deviation, wherein the optimized registration matrix is a registration matrix corresponding to a less one of the first deviation and the second deviation.

9. (canceled)

10. A computer-readable storage medium, comprising a stored program, wherein the program executes the method according to claims 1.

11. A processor, configured to run a program, wherein the program executes the method according to claims 1 when run.

12. The computer-readable storage medium according to claim 10, comprising a stored program, wherein the determining an optimized registration matrix according to a mean of first registration errors and a mean of second registration errors comprises: obtaining a first registration error matrix through an iterative closest point algorithm, wherein the first registration error matrix comprises N first registration errors, and the predetermined point is another second marker point closest to the second marker point; obtaining a second registration error matrix through the iterative closest point algorithm, wherein the second registration error matrix comprises N second registration errors; and determining an optimized registration error matrix and the optimized registration matrix according to the first registration error matrix and the second registration error matrix, wherein the optimized registration error matrix is a matrix having a less mean of matrix elements of the first registration error matrix and the second registration error matrix, and the optimized registration matrix is a registration matrix corresponding to the optimized registration error matrix.

13. The computer-readable storage medium according to claim 10, comprising a stored program, wherein the determining an optimized registration matrix according to a mean of first registration errors and a mean of second registration errors comprises: determining, in cases that all first target differences are less than or equal to a difference threshold and all the second registration errors corresponding to the third marker points are less than or equal to an error threshold, the matrix having a less mean of matrix elements of the first registration error matrix and the second registration error matrix as the optimized registration error matrix, and determining a matrix corresponding to the optimized registration error matrix in the secondary registration matrix and the tertiary registration matrix as the optimized registration matrix, wherein the first target difference is a difference between the second registration error corresponding to the third marker point and the second registration error corresponding to the deleted second marker point; and deleting, in at least one of cases that any first target difference is greater than the difference threshold and the second registration error corresponding to any third marker point is greater than an error threshold, all third marker points having differences greater than the difference threshold and all third marker points having second registration errors greater than the error threshold, determining remaining third marker points as Xth marker points, wherein X is greater than 3, re-registering the primary registration model with the actual pelvis according to the Xth marker point to obtain an X-ary registration model and an X-ary registration matrix, executing computation through the iterative closest point algorithm to obtain an (X−1)th registration error matrix, wherein the (X−1)th registration error matrix comprises a plurality of (X−1)th registration errors, the (X−1)th registration error is a root mean square error of a (2X−3)th distance and a (2X−2)th distance, the (2X−3)th distance is a distance between the Xth marker point and an (X−1)th predetermined point, and the (2X−2)th distance is a distance between a corresponding point of the Xth marker point in the X-ary registration model and a corresponding point of the (X−1)th predetermined point in the X-ary registration model, repeating the point deletion step and the tertiary registration step until a first case or a second case occurs, wherein the first case is that all second target differences are less than or equal to the difference threshold and all the (X−1)th registration errors are less than or equal to the error threshold, and the second case is that the quantity of all the deleted points is greater than or equal to a predetermined quantity, determining a matrix having a minimum mean of matrix elements of the first registration error matrix, the second registration error matrix and all (X−1)th registration error matrices as the optimized registration error matrix, and determining a matrix corresponding to the optimized registration error matrix in the secondary registration matrix, the tertiary registration matrix and all X-ary registration matrices as the optimized registration matrix, wherein the second target difference is a difference between the Xth registration error corresponding to the (X−1)th marker point and an (X−2)th registration error corresponding to the (X−1)th deleted marker point.

14. The computer-readable storage medium according to claim 10, comprising a stored program, wherein after the determining a registration model corresponding to the optimized registration matrix as an optimized registration model, the method further comprises: rotating the optimized registration model around a rotation axis by a predetermined angle to obtain a rotation model, wherein the predetermined angle is any angle from −180° to 180°;updating the primary registration model to the rotation model; repeating the secondary registration step, the point deletion step, the tertiary registration step, the first determination step and the second determination step to obtain an optimized registration error matrix and an optimized registration model corresponding to the predetermined angle; and determining a target rotation angle according to optimized registration error matrices corresponding to a plurality of predetermined angles, wherein the target rotation angle is the predetermined angle corresponding to the optimized registration error matrix having a minimum mean of matrix elements of the optimized registration error matrices corresponding to the plurality of predetermined angles.

15. The computer-readable storage medium according to claim 10, comprising a stored program, wherein the determining a target rotation angle according to optimized registration error matrices corresponding to a plurality of predetermined angles comprises: determining a preliminary registration model according to the optimized registration error matrices corresponding to −180° and a plurality of first predetermined angles spaced from each other by a first interval angle, wherein the preliminary registration model is the optimized registration model corresponding to a preferred angle of the optimized registration error matrix having a minimum mean of matrix elements of the optimized registration error matrices corresponding to −180° and the first predetermined angles, a difference between a minimum first predetermined angle and −180° is less than or equal to the first interval angle, and a difference between 180° and a maximum first predetermined angle is less than or equal to the first interval angle; and determining the target rotation angle according to the optimized registration error matrices corresponding to a minimum angle, a maximum angle and a plurality of second predetermined angles spaced from each other by a second interval angle, wherein the target rotation angle is the second predetermined angle corresponding to the optimized registration error matrix having a minimum mean of matrix elements of the optimized registration error matrices corresponding to the minimum angle, the maximum angle and the second predetermined angle, the second interval angle is less than the first interval angle, the minimum angle is a difference between the preferred angle and the first interval angle, and the maximum angle is the sum of the preferred angle and the first interval angle.

16. The computer-readable storage medium according to claim 10, comprising a stored program, wherein the determining a target rotation angle according to optimized registration error matrices corresponding to a plurality of predetermined angles comprises:
determining a preliminary registration model according to the optimized registration error matrices corresponding to −180° and a plurality of first predetermined angles spaced from each other by a first interval angle, wherein the preliminary registration model is the optimized registration model corresponding to a preferred angle of the optimized registration error matrix having a minimum mean of matrix elements of the optimized registration error matrices corresponding to −180° and the first predetermined angles, a difference between a minimum first predetermined angle and −180° is less than or equal to the first interval angle, and a difference between 180° and a maximum first predetermined angle is less than or equal to the first interval angle; and
determining the target rotation angle according to the optimized registration error matrices corresponding to a minimum angle, a maximum angle and a plurality of second predetermined angles spaced from each other by a second interval angle, wherein the target rotation angle is the second predetermined angle corresponding to the optimized registration error matrix having a minimum mean of matrix elements of the optimized registration error matrices corresponding to the minimum angle, the maximum angle and the second predetermined angle, the second interval angle is less than the first interval angle, the minimum angle is a difference between the preferred angle and the first interval angle, and the maximum angle is the sum of the preferred angle and the first interval angle.

17. The processor according to claim 11, comprising a stored program, wherein the determining an optimized registration matrix according to a mean of first registration errors and a mean of second registration errors comprises: obtaining a first registration error matrix through an iterative closest point algorithm, wherein the first registration error matrix comprises N first registration errors, and the predetermined point is another second marker point closest to the second marker point; obtaining a second registration error matrix through the iterative closest point algorithm, wherein the second registration error matrix comprises N second registration errors; and determining an optimized registration error matrix and the optimized registration matrix according to the first registration error matrix and the second registration error matrix, wherein the optimized registration error matrix is a matrix having a less mean of matrix elements of the first registration error matrix and the second registration error matrix, and the optimized registration matrix is a registration matrix corresponding to the optimized registration error matrix.

18. The processor according to claim 11, comprising a stored program, wherein the determining an optimized registration matrix according to a mean of first registration errors and a mean of second registration errors comprises: determining, in cases that all first target differences are less than or equal to a difference threshold and all the second registration errors corresponding to the third marker points are less than or equal to an error threshold, the matrix having a less mean of matrix elements of the first registration error matrix and the second registration error matrix as the optimized registration error matrix, and determining a matrix corresponding to the optimized registration error matrix in the secondary registration matrix and the tertiary registration matrix as the optimized registration matrix, wherein the first target difference is a difference between the second registration error corresponding to the third marker point and the second registration error corresponding to the deleted second marker point; and deleting, in at least one of cases that any first target difference is greater than the difference threshold and the second registration error corresponding to any third marker point is greater than an error threshold, all third marker points having differences greater than the difference threshold and all third marker points having second registration errors greater than the error threshold, determining remaining third marker points as Xth marker points, wherein X is greater than 3, re-registering the primary registration model with the actual pelvis according to the Xth marker point to obtain an X-ary registration model and an X-ary registration matrix, executing computation through the iterative closest point algorithm to obtain an (X−1)th registration error matrix, wherein the (X−1)th registration error matrix comprises a plurality of (X−1)th registration errors, the (X−1)th registration error is a root mean square error of a (2X−3)th distance and a (2X−2)th distance, the (2X−3)th distance is a distance between the Xth marker point and an (X−1)th predetermined point, and the (2X−2)th distance is a distance between a corresponding point of the Xth marker point in the X-ary registration model and a corresponding point of the (X−1)th predetermined point in the X-ary registration model, repeating the point deletion step and the tertiary registration step until a first case or a second case occurs, wherein the first case is that all second target differences are less than or equal to the difference threshold and all the (X−1)th registration errors are less than or equal to the error threshold, and the second case is that the quantity of all the deleted points is greater than or equal to a predetermined quantity, determining a matrix having a minimum mean of matrix elements of the first registration error matrix, the second registration error matrix and all (X−1)th registration error matrices as the optimized registration error matrix, and determining a matrix corresponding to the optimized registration error matrix in the secondary registration matrix, the tertiary registration matrix and all X-ary registration matrices as the optimized registration matrix, wherein the second target difference is a difference between the Xth registration error corresponding to the (X−1)th marker point and an (X−2)th registration error corresponding to the (X−1)th deleted marker point.

19. The processor according to claim 11, comprising a stored program, wherein after the determining a registration model corresponding to the optimized registration matrix as an optimized registration model, the method further comprises:
rotating the optimized registration model around a rotation axis by a predetermined angle to obtain a rotation model, wherein the predetermined angle is any angle from −180° to 180°; updating the primary registration model to the rotation model; repeating the secondary registration step, the point deletion step, the tertiary registration step, the first determination step and the second determination step to obtain an optimized registration error matrix and an optimized registration model corresponding to the predetermined angle; and determining a target rotation angle according to optimized registration error matrices corresponding to a plurality of predetermined angles, wherein the target rotation angle is the predetermined angle corresponding to the optimized registration error matrix having a minimum mean of matrix elements of the optimized registration error matrices corresponding to the plurality of predetermined angles.

20. The processor according to claim 11, comprising a stored program, wherein the determining a target rotation angle according to optimized registration error matrices corresponding to a plurality of predetermined angles comprises: determining a preliminary registration model according to the optimized registration error matrices corresponding to −180° and a plurality of first predetermined angles spaced from each other by a first interval angle, wherein the preliminary registration model is the optimized registration model corresponding to a preferred angle of the optimized registration error matrix having a minimum mean of matrix elements of the optimized registration error matrices corresponding to −180° and the first predetermined angles, a difference between a minimum first predetermined angle and −180° is less than or equal to the first interval angle, and a difference between 180° and a maximum first predetermined angle is less than or equal to the first interval angle; and determining the target rotation angle according to the optimized registration error matrices corresponding to a minimum angle, a maximum angle and a plurality of second predetermined angles spaced from each other by a second interval angle, wherein the target rotation angle is the second predetermined angle corresponding to the optimized registration error matrix having a minimum mean of matrix elements of the optimized registration error matrices corresponding to the minimum angle, the maximum angle and the second predetermined angle, the second interval angle is less than the first interval angle, the minimum angle is a difference between the preferred angle and the first interval angle, and the maximum angle is the sum of the preferred angle and the first interval angle.

21. The processor according to claim 11, comprising a stored program, wherein the determining a target rotation angle according to optimized registration error matrices corresponding to a plurality of predetermined angles comprises:
determining a preliminary registration model according to the optimized registration error matrices corresponding to −180° and a plurality of first predetermined angles spaced from each other by a first interval angle, wherein the preliminary registration model is the optimized registration model corresponding to a preferred angle of the optimized registration error matrix having a minimum mean of matrix elements of the optimized registration error matrices corresponding to −180° and the first predetermined angles, a difference between a minimum first predetermined angle and −180° is less than or equal to the first interval angle, and a difference between 180° and a maximum first predetermined angle is less than or equal to the first interval angle; and
determining the target rotation angle according to the optimized registration error matrices corresponding to a minimum angle, a maximum angle and a plurality of second predetermined angles spaced from each other by a second interval angle, wherein the target rotation angle is the second predetermined angle corresponding to the optimized registration error matrix having a minimum mean of matrix elements of the optimized registration error matrices corresponding to the minimum angle, the maximum angle and the second predetermined angle, the second interval angle is less than the first interval angle, the minimum angle is a difference between the preferred angle and the first interval angle, and the maximum angle is the sum of the preferred angle and the first interval angle.
